(19) United States
(12) Patent Application Publication
(10) Pub. No.: US 2010/0011220 A1
(43) Pub. Date: Jan. 14, 2010

(54) AUTHENTICATION AND KEY AGREEMENT METHOD, AUTHENTICATION METHOD, SYSTEM AND DEVICE

(76) Inventors: Jie ZHAO, Shenzhen (CN); Fang YOU, Shenzhen (CN); Wenyu LIU, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/562,368

(22) Filed: Sep. 18, 2009

Related U.S. Application Data
(63) Continuation of application No. PCT/CN2008/070546, filed on Mar. 20, 2008.

(30) Foreign Application Priority Data
Mar. 22, 2007 (CN) 200710089942.1

(51) Int. Cl. H04L 9/32; G06F 21/00

(52) U.S. Cl. 713/182; 726/28

(57) ABSTRACT

An AKA method, and authentication method and related devices are disclosed so that a user card not supporting storing of a SQN can resist replay attacks during an AKA procedure. In an AKA method, a second device generates a fourth sequence number for a user according to system time of the second device if the second device determines that the fourth sequence number for the user is not stored in the second device and synchronizing a third sequence number of the user that is stored by a first device with the fourth sequence number by interacting with the first device. The second device and the first device may perform an anti-replay protection in authentication using the synchronized third sequence number and the fourth sequence numbers. In the AKA method, a terminal can generate a SQN based on the system time and a random number which makes the SQN value more random. Even if an attacker knows the time value or even controls the system time of the terminal, the attacker is unable to predict the SQN generated by the terminal so that a replay attack is improbable. The security is thus enhanced.

### CROSS-REFERENCE TO RELATED APPLICATION

This application is a continuation of International Patent Application No. PCT/CN2008/070546, filed on Mar. 20, 2008, which claims a priority from the Chinese Patent Application No. 200710089942.1, filed with the Chinese Patent Office on Mar. 22, 2007 and titled “Authentication and Key Agreement Method, Authentication Method, System and Device”, the contents of both of which are incorporated herein by reference in their entirety.

### TECHNICAL FIELD

The present disclosure relates to communication technologies, and in particular, to an Authentication and Key Agreement (AKA) method, a terminal device, an AKA system, an authentication methods and a corresponding communication device.

### BACKGROUND

With the progress of technologies, it has become a trend of network development for a traditional core network to evolve toward an all Internet Protocol (IP) network. The IP Multimedia Subsystem (IMS) proposed by the 3rd Generation Partnership Project (3GPP) in R5/R6 standards is a system specially designed for the next generation all-IP multimedia mobile networks. The standard intends to bear mobile multimedia services over IP so that operators and end users can get faster and more flexible applications from the revolution of multimedia services, thus helping the operators increase revenue and profit.

The 3rd Generation Partnership Project 2 (3GPP2) has already formulated the related IMS specifications under the Multimedia Domain (MMD) standard. Basically, each entity and interface in the MMD has one counterpart in the 3GPP IMS.

The IMS is a system based on the Session Initiation Protocol (SIP), which is a text based information protocol working in the client/server mode. The IMS uses the SIP call control mechanism to create, manage and terminate various multimedia services.

The IMS architecture defined by 3GPP includes functional entities such as Call Session Control Function (CSCF), Media Gateway Control Function (MGCF), Multimedia Resource Function (MSF) and Home Subscriber Server (HSS).

The CSCF may be categorized into three logical entities: Serving CSCF (S-CSCF), Proxy CSCF (P-CSCF) and Interrogating CSCF (I-CSCF). In an IMS system, the S-CSCF is a service switching center and executes session control, manages user information and generates charging information. The P-CSCF is an access point for an end user to access the IMS system. The P-CSCF completes user registration, and is responsible for Quality of Service (QoS) control and security management. The I-CSCF is responsible for the communication between IMS domains, manages S-CSCF assignment, hides the network topology from the outside and generates charging data.

A terminal needs to register with the IMS core network entity before initiating a call. The registration procedure enables the terminal to use the IMS service. An IMS registration is completed via a procedure based on Authentication and Key Agreement (AKA).

In the AKA procedure, a terminal first sends to the network an authentication request which carries the user identity. The network obtains a key shared by the terminal and the network according to the user identity in the authentication request and computes an Authentication Vector (AV) according to the shared key. The AV includes five parameters: Random challenge (RAND), Authentication Token (AUTN), Expected Response (XRES), Integrity Key (IK) and Cipher Key (CK). The AUTN further includes two parameters: Sequence Number (SQN) and Message Authentication Code (MAC). The MAC value is computed according to the RAND, SQN and the shared key of the terminal and the network, and used for the terminal to authenticate the network. Then, the network sends the RAND and AUTN to the terminal via an Auth_Challenge message. Upon reception of the challenge message, the terminal computes the corresponding XMAC according to the RAND, SQN and the shared key of the terminal and the network and compares the XMAC and the MAC in the Auth_Challenge message. If they are identical, the terminal continues to check whether the received SQN is larger than the locally stored SQN or to check whether the received SQN is larger than the locally stored SQN with a difference within a preset range. If so, the terminal authenticates the network successfully. Then, the terminal computes the RES, IK and CK according to the RAND. The RES is a parameter for the network to authenticate the terminal. Afterwards, the terminal sends to the network an authentication response message (SIP Register) which carries the user identity, with the RES as the key of the authentication response message. The network finds the corresponding XRES according to the user identity in the authentication response message to check the RES so as to determine whether the response message is legal. If the response message is legal, the authentication is successful.

Therefore, in an AKA procedure, an authentication is successful only when the terminal has authenticated the network and the network has authenticated the terminal.

To guarantee that the terminal authenticates the network effectively to implement the AKA procedure, the terminal needs to store a SQN locally and accordingly, the network needs to store a SQN for the terminal. The SQN stored in the terminal and the SQN stored in the network need to be synchronized. Every time after the network sends a challenge message and the terminal checks the SQN, the SQN changes on both sides with a monotonic increase. Therefore, upon reception of the Auth_Challenge message from the network, the terminal may determine whether the Auth_Challenge is fresh by checking whether the SQN in the AV carried in the message is larger than the locally stored SQN or whether the received SQN is larger than the locally stored SQN with a difference within a present range. If the SQN in the received Auth_Challenge is larger than the local SQN of the terminal, or if the received SQN is larger than the local SQN with a difference within the preset range, the SQN in the Auth_Challenge message is valid. Otherwise, the terminal considers the message a replay attack (which means the message is intercepted and retransmitted by an illegal network) which is insecure. In this case, the terminal initiates a resynchronization procedure with the network so that the SQN stored in the network is resynchronized with the SQN stored by the terminal.

In an authentication procedure, both the terminal and the network need to use the user identity, the SQN and the shared key of the terminal and the network, which are stored in an IMS Subscriber Identity Module (ISIM). Therefore, an IMS enabled terminal normally needs to include an ISIM. This module is a part of a 3G Universal Subscriber Identity Module (USIM) Integrated Circuit Card (UICC) or a Removable User Identity Module (R-UIM). A user card without ISIM is unable to complete an IMS registration.

To store the user identity, SQN and IMS shared key in a user card of the terminal ensures the security of these parameters. If a terminal has no UICC or R-UIM, these parameters are stored in the secure memory of the terminal. Such a terminal can only serve one user.

At present, some operators hope to provide IMS services for users using the 2^{nd} Generation (2G) cards. Therefore, it is necessary to consider how to store the parameters (IMS key and SQN) for these users. One method is to generate the IMS key dynamically and to maintain and store the SQN on the user terminal, a user device with the user card removed.

The inventor, however, finds that, in this method, because the SQN is stored in the terminal, when the user changes the terminal, the new terminal needs to generate a new SQN which may not be associated with the old SQN. As a result, the monotonic increase feature of the SQN is not guaranteed, which may introduce replay attacks in networks. For example, a user performs IMS registration authentication at terminal 1 using a 2G user card. The AKA procedure uses the SQN stored in terminal 1 to authenticate the network. After this network authentication, the SQN stored in terminal 1 will have a monotonic increase. Afterwards, the user performs another authentication at terminal 2 using the same 2G card. The SQN regenerated by terminal 2 for the user may be smaller than the earlier SQN (the monotonic increase feature is not guaranteed). In this case, if an illegal network intercepts the Auth_Challenge message of the earlier authentication to start a replay attack, the terminal mistakes the illegal message for a legal Auth_Challenge. This means the terminal is unable to resist the replay attack.

### SUMMARY

The disclosed embodiments provide an Authentication and Key Agreement (AKA) method, authentication method, a system and a device so that a user card that does not store a SQN can resist replay attacks during an AKA procedure.

An authentication method is provided. The authentication method may include:

generating, by a second device, a fourth sequence number for a user according to system time of the second device if the second device determines that a fourth sequence number of the user is not stored in the second device and synchronizing a third sequence number of the user that is stored by a first device with the fourth sequence number by interacting with the first device; and

performing, by the second device and the first device, an anti-replay protection in authentication using the synchronized third sequence number and the fourth sequence numbers.

A communication device includes:

a first storage unit, configured to store a fourth sequence number of a user;

a generating unit, configured to generate the fourth sequence number according to system time of the communication device after it is determined that the first storage unit does not store the fourth sequence number for the user to be authenticated, and configured to instruct the first storage unit to store the fourth sequence number;

a first synchronization unit, configured to synchronize a third sequence number of the user stored by a peer device with the fourth sequence number by communicating with the another communication device; and

a first authenticating unit, configured to perform an anti-replay authentication on interactive messages with the peer device by using the synchronized fourth sequence number.

An AKA method applicable to a terminal device is provided. The AKA method applicable to a terminal device may include:

sending, by a terminal, a registration request or an authentication request to a network;

obtaining, by the terminal, from the network a first sequence number that represents current system time of the network and a random number and a first authentication code of the network, wherein the first authentication code is generated by the network according to a shared key between the network the terminal, the random number and the first sequence number;

checking, by the terminal, the first sequence number and the first authentication code and determining that the network is legal when the following condition is met:

a second authentication code generated according to the shared key, the random number and the first sequence number is identical with the first authentication code; and difference between the second sequence number that represents current system time of the terminal and the first sequence number meets a preset condition.

In some embodiments, if a second device determines that a fourth sequence number of the user to be authenticated is not stored locally, the second device generates a fourth sequence number according to the system time of the second device and interacts with a first device so as to synchronize the third sequence number of the user stored by the first device with the fourth sequence number. The second device and the first device use the synchronized third and fourth sequence numbers to perform an anti-replay authentication on the interactive messages. The third sequence number stored by the first device increases with the increase of authentications and the system time increases automatically. Because it may be determined that the frequency of automatic increase of system time is higher than authentication frequency of the second device, the fourth sequence number generated according to the system time is larger than the third and fourth sequence numbers previously stored by the first device and the user terminal. For example, if the authentication frequency of the second device is once 10 seconds, a fourth sequence number may be generated according to the total number of seconds associated with the system time. If the authentication frequency of the second device is once 10 milliseconds, a fourth sequence number may be generated according to the total number of milliseconds associated with the system time. In this way, the fourth sequence number generated according to the system time may be larger than the sequence number obtained by increase with each authentication. Therefore, when the fourth sequence number generated according to the system time is adopted for the synchronization of sequence numbers between the first device and the second device, the sequence number after the resynchronization will increase while the currently stored third and fourth sequence numbers are unknown. This enables effective resistance against replay attacks and is especially fit for a resynchronization in the case that a user card which cannot store a fourth sequence number changes a terminal device.

In other embodiments, a terminal sends an authentication request and obtains from the network a first sequence number that represents current system time of the network and a random number and a first authentication code of the network. When a second authentication code generated according to a shared key with the network, the random number and the first sequence number is identical with the first authentication code and the difference between a second sequence number that represents current system time of the terminal and the first sequence number meets a preset condition, the terminal determines that the network is legal. Because each terminal automatically determines a unique system time, it is not necessary for the terminal to generate a sequence number for the current authentication according to the sequence number of the last authentication. Even if the user card cannot store the sequence number of the last authentication or if the user card has changed to another terminal after the last authentication, a unique and correct sequence number is generated for the current authentication. Therefore, the terminal does not mistake the random number, first sequence number and first authentication code replayed by an illegal network for legal ones due to an uncertain or incorrect sequence number so that replay attacks are effectively resisted.

### BRIEF DESCRIPTION OF THE DRAWINGS

FIG. 1 shows the procedure of an AKA method in a first embodiment;

FIG. 2 shows the procedure of an AKA method in a second embodiment;

FIG. 3 shows the procedure of an AKA method in a third embodiment;

FIG. 4 show the procedure of an authentication method in a sixth embodiment;

FIG. 5 shows the procedure of an authentication method in a seventh embodiment;

FIG. 6 shows the structure of a terminal device in a fourth embodiment;

FIG. 7 shows the structure of an AKA system in a fifth embodiment;

FIG. 8 shows the structure of a communication device in an eighth embodiment; and

FIG. 9 shows the structure of a communication device in a ninth embodiment.

### DETAILED DESCRIPTION

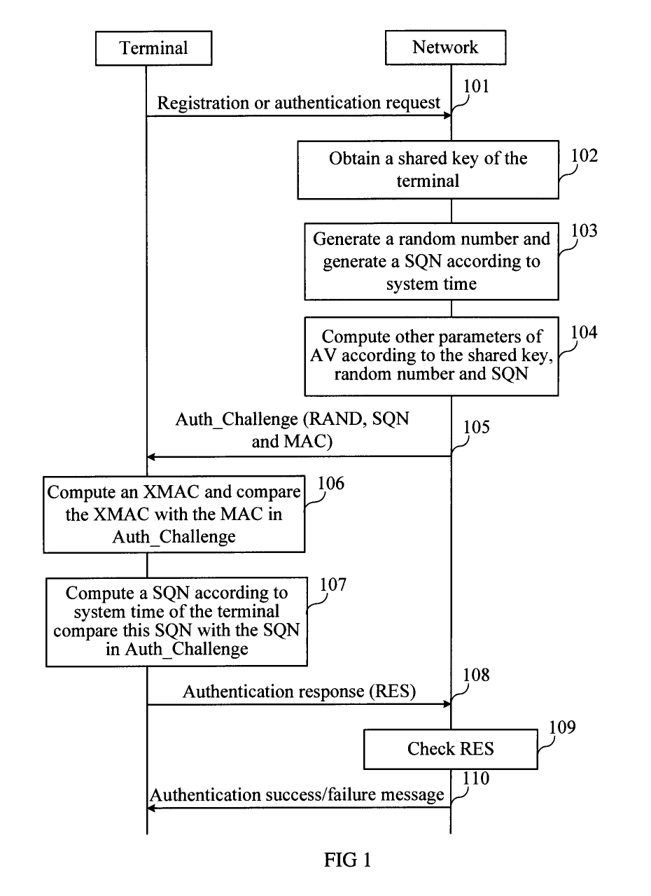

FIG. 1 shows the procedure of an Authentication and Key Agreement (AKA) method according to a first embodiment. The procedure may include the following steps:

Step 101: A terminal sends a registration request or an authentication request to a network, the registration request or the authentication request carrying a user identity.

Step 102: Upon reception of the registration request or the authentication request, the network finds the corresponding user information according to the user identity in the request message to obtain the shared key K with the terminal and uses the shared key K as an authentication key. If the network does not find a shared key in the user information, the network may generate an authentication key via another means.

Step 103: The network generates a RAND and obtains the system time, which may be converted into a 48-bit SQN value. There are many methods to convert the system time into a SQN value depending on the required precision. If the required precision is not high, the total of seconds of the system time may be converted into a SQN value; if the required precision is high, the total of seconds and milliseconds may be converted into a SQN value, for example, place the seconds in the most significant 32 bits of the SQN and the milliseconds in the least significant 16 bits of the SQN. In addition, in this embodiment, the SQN is a 48-bit numeric value. In practice, the SQN may be a value of more or less than 48 bits.

Step 104: The network computes the other parameters of an Authentication Vector (AV) according to the shared key K, a RAND and the SQN. The AV includes a RAND, an AUTN, an XRES, an IK and a CK, where the AUTN further includes the SQN and a MAC. This means, the network computes a MAC, an XRES, an IK and a CK based on the shared key K, the RAND and the SQN. The MAC and the SQN are used by the terminal to authenticate the network and the XRES is used by the network to authenticate the terminal afterwards.

Step 105: The network sends the RAND and the AUTN (including the SQN and the MAC) as parameters of an Auth_Challenge message to the terminal.

Step 106: The terminal receives the Auth_Challenge message and computes an XMAC according to the RAND and the SQN in the Auth_Challenge message and the shared key K stored in the terminal, in the same method as the network uses to compute the MAC. The terminal also checks whether the XMAC is identical with the MAC in the received Auth_Challenge message. If the XMAC is different from the MAC, the terminal determines that the currently received Auth_Challenge is illegal and terminates the authentication procedure, and the authentication fails. If the XMAC and the MAC are identical, step 107 proceeds.

Step 107: The terminal checks the SQN value. The validity of SQN may be determined in the same or in a similar manner as a prior AKA procedure. The terminal first obtains the current system time and converts the system time into a 48-bit SQN value. The terminal compares the SQN converted computed by the terminal with the SQN in the received Auth_Challenge. If the preset condition is met, the SQN check is successful, which indicates that the terminal and the network are synchronized and the Auth_Challenge is fresh. Then, the terminal authenticates the network successfully and step 108 continues. If the preset condition is not met, the terminal considers the message is replayed and the authentication fails. The procedure is then terminated. The preset condition may be: the absolute value of the difference between the SQN in the received Auth_Challenge and the SQN computed by the terminal is smaller than a threshold; or the difference between the SQN in the received Auth_Challenge and the SQN computed by the terminal is within a preset range. Those skilled in the art should understand that the preset condition may be set according to actual needs and the required authentication precision.

Step 108: After the terminal authenticates the network successfully, the terminal computes the RES, IK and CK according to the RAND in the received Auth_Challenge and the shared key K stored in the terminal and sends the RES to the network in a response message.

Step 109: Upon reception of the response message, the network checks the RES in the response message by using the previously computed XRES. If the check is successful, the network finishes authenticating the terminal. Otherwise, the authentication fails.

Step 110: The network sends an authentication success (or authentication failure) message according to the authentication result. The authentication ends. Afterwards, the network and the terminal may transmit data according to the IK and CK values they compute.

In addition, consistent with some embodiments, the system time on the terminal and the network may be synchronized before an authentication. A clock synchronization procedure may be initiated before the terminal sends the registration request or the authentication request, or before the network sends the Auth_Challenge to the terminal so that the difference between the system time on the both sides is within an insignificant range, thus ensuring that the terminal accurately judges the legality of the received Auth_Challenge message.

In addition, consistent with some embodiments, if the terminal detects that the SQN is unsynchronized, the terminal may send the local SQN to the network so that the network is resynchronized with the terminal. Or, in a strictly clock synchronized network, the terminal may not initiate the resynchronization procedure, but starts a new authentication or registration.

In the first embodiment provides AKA method. The greatest difference from the prior AKA method lies in the setting of the SQN parameter. In the prior AKA method, SQN is a concept of counter. The user terminal and the network maintain a counter respectively and keep the two counters synchronized. The user terminal may determine whether the network device that sends the SQN is legal by checking whether the counter value (SQN) sent from the network is consistent with the locally maintained counter value (SQN). This method requires that one user should maintain a SQN uniformly. In the case that the SQN is stored in a user card, one SQN can be maintained uniformly no matter how many terminals the user changes. In the case of a user card that cannot store the SQN, however, because the SQN has to be stored in the terminal where the user card is inserted, when the user inserts one user card into different terminals, the SQN stored in the terminals cannot be unified. As a result, replay attacks are likely to occur during an authentication. Consistent with this embodiment, the SQN parameter is still used. Rather than using a counter value, the clock value of the systems, such as the time stamp, is used. Because both the terminal and the network have clocks, even if a user card is not able to store the SQN, or if the user card needs to be inserted into different terminals, the SQN in different terminals will be consistent so long as the terminal and the network are synchronized. In this way, replay attacks are effectively resisted.

The second embodiment provides an AKA method. In this embodiment, a Code Division Multiple Access 2000 (CDMA2000) network authenticates a terminal.

This embodiment may also utilize the unidirectional feature of time to determine a replay attack. The network may represent its system time as a 48-bit SQN and send the SQN to a terminal by carrying the SQN in an Auth_Challenge message. Upon reception of the Auth_Challenge from the network, the terminal makes a judgment according to the current system of the terminal. If the time value represented by the SQN sent from the network does not meet the preset condition in comparison with a SQN represented the current time value on the terminal, for example, the absolute value of the difference between the two SQNs is larger than a preset threshold, the terminal considers the SQN is not synchronized and this message is a replayed by an attacker. In this case, the terminal terminates the authentication. Unlike the prior AKA procedure, in this embodiment, if the terminal detects that the SQN is unsynchronized, the terminal may send the local SQN to the network so that the network is resynchronized with the terminal. Or, in a strictly clock synchronized network, the terminal may not initiate the resynchronization procedure, but only starts a new authentication or registration.

The following describes an authentication procedure where a terminal using a 2G user card requests to access an IMS domain in a CDMA2000 network. For a CDMA2000 network, the physical layer needs to be so designed as to ensure that the terminal clock is strictly synchronized with the network. Therefore, a CDMA2000 terminal has a very precise clock so that the authentication procedure can start directly without a synchronization procedure.

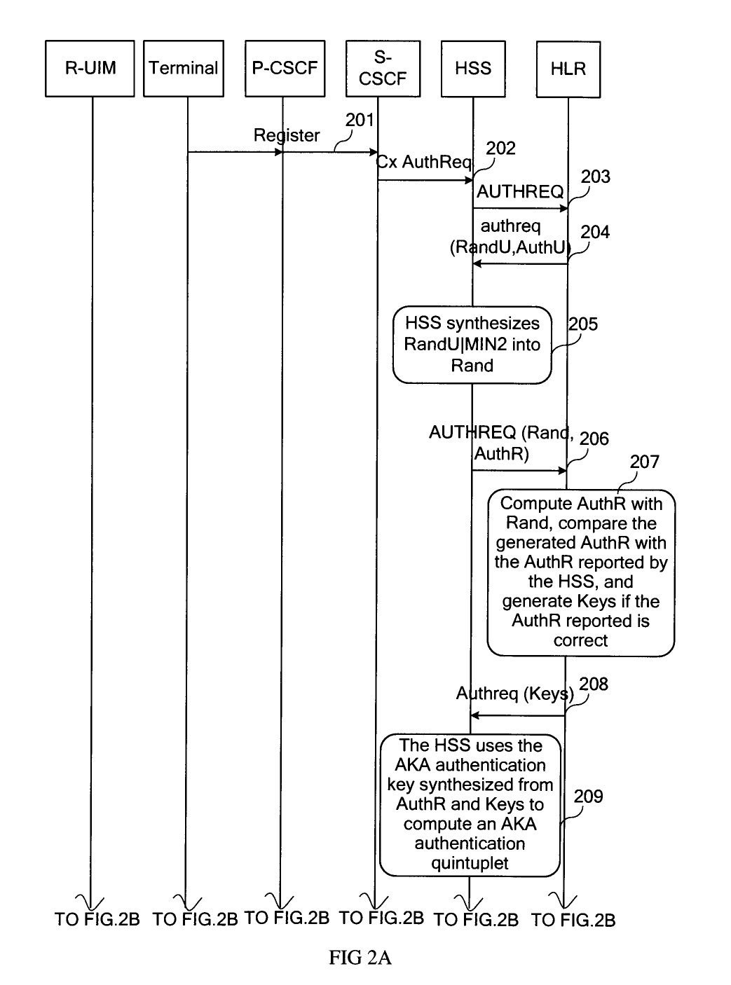

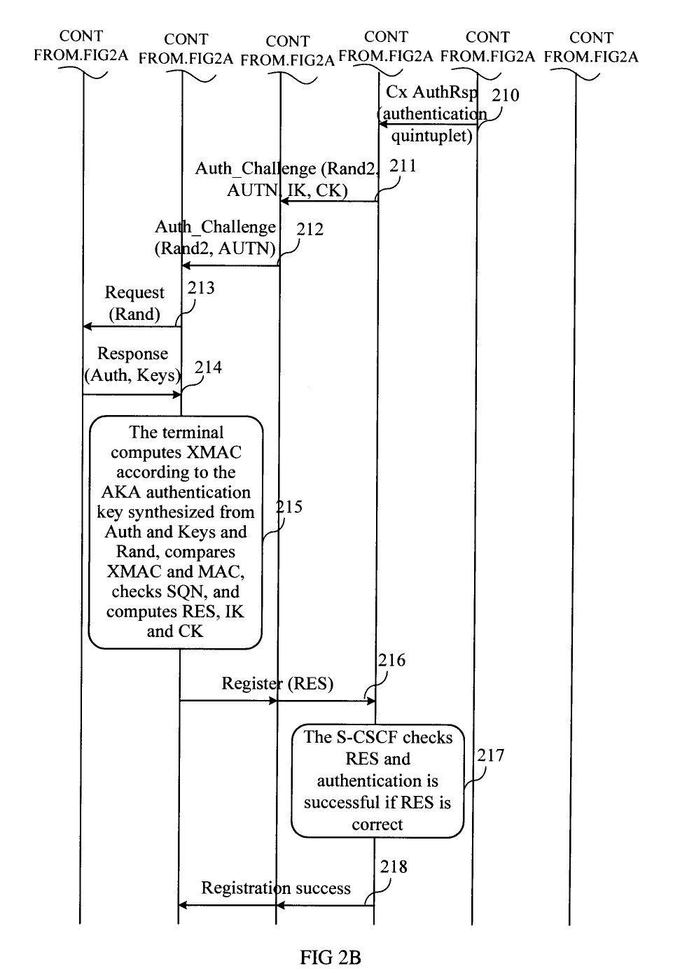

As shown in FIG. 2, the authentication procedure includes the following steps:

Step 201: A terminal sends a MMD registration request to a P-CSCF, the registration request carrying an IP Multimedia Private Identity (IMPI). The P-CSCF forwards the registration request to an S-CSCF.

Step 202: The S-CSCF sends a Cx AuthReq to an HSS, requesting authentication data of the terminal. The Cx AuthReq carries the IMPI of the terminal.

Step 203: The HSS finds that the terminal uses a 2G user card and restores an International Mobile Subscriber Identity (IMSI) from the IMPI of the terminal. Then the HSS sends an AUTHREQ to the Home Location Register (HLR) to request authentication data of the terminal.

Step 204: The HLR executes a 2G authentication procedure and generates a RandU and applies the Cellular Authentication and Voice Encryption (CAVE) algorithm on the RandU to generate the authentication data AuthU. The HLR sends the RandU and the RandU to the HSS via a response message authreq.

Step 205: The HSS synthesizes the received RandU and the MIN2 in the IMSI of the terminal into a Rand parameter.

Step 206: The HSS uses the AuthU as an AuthR and sends the AuthR together with the Rand to the HLR in an AUTHREQ to start another 2G global challenge. The AUTHREQ message carries a flag that requests the HLR to return Keys.

Step 207: Upon reception of the AUTHREQ, the HLR performs a CAVE computation on the Rand in the message to get an AuthR and compares the computed AuthR with the AuthR in the AUTHREQ reported by the HSS. If the two AuthR values are consistent, the HLR performs a CAVE computation on the AuthR to get the Keys. The Keys is made up of a Signaling Message Encryption Key (SMEKEY) and a CDMA Private Long Code Mask (CDMAPLCM).

Step 208: The HLR sends a response message, for example, an authreq to the HSS, returning the Keys to the HSS.

Step 209: The HSS gets five authentication parameters (including AUTN, XRES, IK, CK and Rand2, where AUTN further includes MAX and SQN) for the AKA algorithm through the AuthR and the Keys. The five authentication parameters are equivalent to an Authentication Vector (AV). Specifically, the HSS uses the AuthR and the Keys to generate an AKA authentication key (SMEKEY∥CDMAPLCM∥AuthR) and the 128-bit Rand2 for the AKA algorithm (the HSS may first generate a 96-bit RandT, and Rand2=RandT∥Rand). Then, the HSS obtains the system time and converts it into a 48-bit value as the SQN. The HSS executes the AKA algorithm on the authentication key, Rand2 and SQN to compute the other parameters (MAC, XRES, IK and CK).

Step 210: The HSS returns a Cx AuthRsp to the S-CSCF, carrying the five authentication parameters to the S-CSCF.

Step 211: The S-CSCF sends the Rand2, AUTN, IK and CK to the P-CSCF via an Auth_Challenge message.

Step 212: The P-CSCF sends the Rand2 and AUTN to the terminal via an Auth_Challenge message.

Step 213: The terminal gets a Rand from the Rand2 and sends the Rand to the user card, a 2G R-UIM.

Step 214: The R-UIM computes an AuthR and a Keys by applying the CAVE algorithm on Rand, where the Keys is the same as that in step 207 which consists of SMEKEY and CDMAPLCM. The R-UIM sends the AuthR and the Keys to the terminal.

Step 215: The terminal gets an AKA authentication key through the AuthR and the Keys and computes the authentication result XMAC by performing the AKA algorithm on the Rand2 sent from the P-CSCF and the SQN in the AUTN. If the XMAC is identical with the MAC in the AUTN sent from the P-CSCF, the terminal continues to check the SQN. Specifically, the terminal obtains its system time and converts the system time into a 48-bit SQN. The terminal compares the converted SQN with the SQN in the AUTN sent from the P-CSCF. If the two are identical or if their difference meets a preset condition, the SQN check is successful, indicating that the terminal and the network are synchronized and the message is fresh. Then, the terminal authenticates the network successfully. The preset condition may be: the absolute value of the difference between the SQN in the received Auth_Challenge and the SQN computed by the terminal is smaller than a threshold; or the difference between the SQN in the received Auth_Challenge and the SQN computed by the terminal is within a preset range. In practice, the preset condition may be set according to actual needs and the required authentication precision so that the application is flexible. After the terminal authenticates the network successfully, the terminal continues to compute RES, IK and CK.

Step 216: The terminal uses the RES to compute the digest of the Register message and sends the digest to the P-CSCF via the Register message. The P-CSCF forwards the Register message to the S-CSCF.

Step 217: The S-CSCF uses the XRES to check the correctness of the RES in the Register message. If the RES is correct, the terminal is authenticated successfully.

Step 218: The S-CSCF sends an authentication success message to the terminal via the P-CSCF. After the registration is successful, the network and the terminal may transmit data according to the IK and CK values they compute.

In this embodiment, because each terminal automatically determines a unique system time, it is not necessary for the terminal to generate a SQN for the current authentication according to the SQN of the last authentication. Even if the user card cannot store the SQN of the last authentication or if the user card has changed to another terminal after the last authentication, a unique and correct SQN is generated for the current authentication. Therefore, the terminal does not mistake an authentication challenge replayed by an illegal network for a legal message due to an uncertain or incorrect SQN so that replay attacks are effectively resisted.

The third embodiment provides another AKA method. This embodiment is based on the AKA in the Extensible Authentication Protocol (EAP) and detailed as follows.

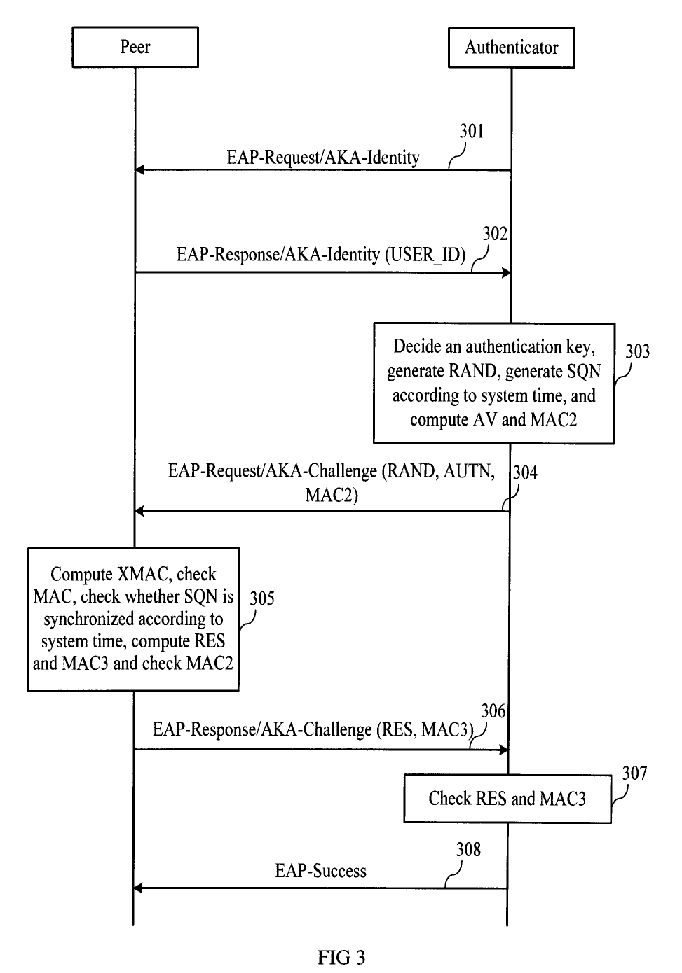

As shown in FIG. 3, the AKA procedure consistent with this embodiment may include the following steps:

Step 301: An authenticator sends an EAP-Request to a peer, requesting the identity of the terminal to be authenticated.

Step 302: The peer sends its identity to the authenticator via an EAP-Response.

Step 303: The authenticator finds the associated user information according to the identity sent from the peer, to obtain the pre-shared key of the peer as the authentication key. If there is no pre-shared key, the authenticator may generate an authentication key in another mode. The authenticator generates a SQN according to the system time and computes the other parameters, XRES, IK, CK, and MAC, of an AV (including AUTN, XRES, IK, CK, and Rand2, where AUTN further includes MAC and SQN) via the pre-shared key (authentication key), the RAND generated by the system and the SQN in the time stamp mode. Because it is necessary to protect the integrity of the EAP AKA message, in this step, the authenticator also needs to compute a Transient EAP Key (TEK) and use the TEK to compute the integrity parameter MAC2 of the EAP AKA message.

Step 304: The authenticator sends the RAND, AUTN and the MAC2 of the EAP AKA message computed on the basis of TEK to the peer via an EAP-Request (or an AKA challenge).

Step 305: The peer computes an XMAC based on the received RAND, the SQN in the AUTN and the pre-shared key of itself. The peer compares the computed XMAC with the MAC in the received AUTN. If they are identical, the peer continues to check whether the SQN in the received AUTN is synchronized with a SQN corresponding to the local clock. If they are synchronized, the peer authenticates the network successfully. The synchronization here may be: the absolute difference between the SQN in the received EAP-Request (or AKA challenge) message and the SQN corresponding to the local clock of the peer is smaller than a preset threshold; or the difference between the SQN in the received EAP-Request (or AKA challenge) message and the SQN corresponding to the local clock of the peer is within a preset range. The synchronization condition may be set according to actual needs and the required authentication precision so that the application is flexible. In addition, the peer also computes a TEK and checks the received MAC2. After the above checks are successful, the peer may compute the IK and CK based on the received RAND, the SQN in the AUTN and the pre-shared key of itself. After the AKA procedure is successful, the IK and CK may be used for data transmission with the authenticator.

Step 306: To insure the integrity of the EAP AKA message, the peer also computes a MAC3 of the EAP AKA message using the TEK and computes a RES based on the RAND in the received EAP-Request (or AKA challenge) message and the shared key of the peer. The peer sends the computed RES and the MAC3 to the authenticator via an EAP-Response (or AKA challenge) message.

Step 307: The authenticator checks the correctness of the MAC3 and compares the RES with the XRES in the previously computed AV. If they are identical, the peer is a legal user and step 308 proceeds.

Step 308: The authenticator sends an EAP Success message to the peer, indicating the peer is successfully authenticated. The EAP AKA procedure ends. Afterwards, the network and the terminal may transmit data according to the IK and CK values they compute.

In this embodiment, because each peer automatically determines a unique system time, it is not necessary for the peer to generate a SQN for the current authentication according to the SQN of the last authentication. Even if the user card cannot store the SQN of the last authentication or if the user card has changed to another peer after the last authentication, a unique and correct SQN is generated for the current authentication. Therefore, the peer does not mistake an authentication challenge replayed by an illegal network for a legal message due to an uncertain or incorrect SQN so that replay attacks are effectively resisted.

In the foregoing embodiments, the system time is converted into a 48-bit value filled in a SQN and may also be converted into a 64-bit value with 48 bits filled in the SQN and the remaining 16 bits filled in another AKA parameter, AMF, so as to increase the precision of system time, so that the authentication is more accurate.

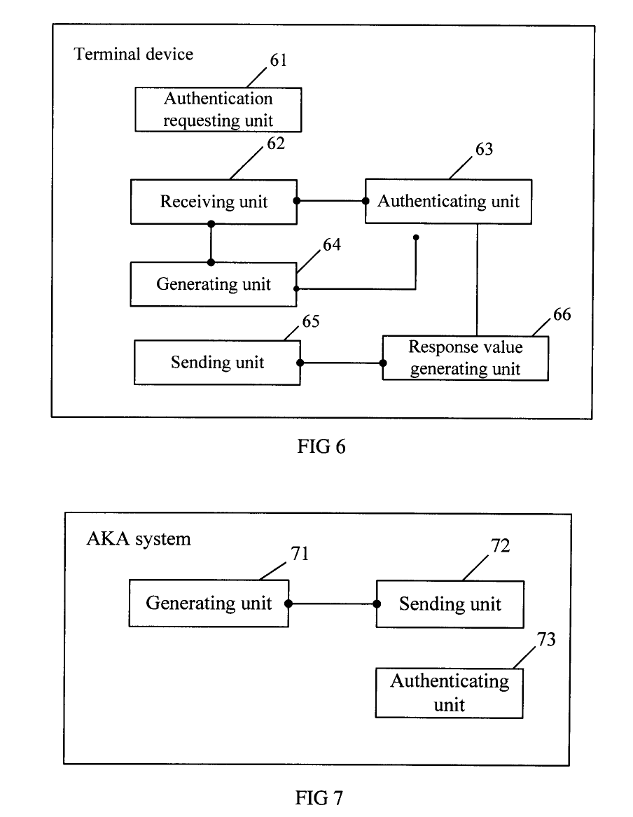

As shown in FIG. 6, the fourth embodiment relates to a terminal device. The terminal device may include:

an authentication requesting unit (61), configured to send a registration request or an authentication request to a network;

a receiving unit (62), configured to receive a first random number, a first sequence number and a first authentication code from the network;

a generating unit (64), configured to generate a second authentication code according to a shared key with the network and the random number received by the receiving unit (62);

an authenticating unit (63), configured to check the first sequence number and the first authentication code received by the receiving unit (62) and determine that the network is legal after finding that the second authentication code generated by the generating unit (64) is identical with the first authentication code and the difference between a second sequence number that represents the current system time of the terminal and the first sequence number meets a preset condition;

a response value generating unit (66), configured to generate a response value according to the shared key with the network and the first random number after the authenticating unit (63) authenticates the network; and

a sending unit (65), configured to send the response value to the network.

The terminal device provided in this embodiment may execute the steps on the terminal in the AKA method in the first, second and third embodiments.

In FIG. 7, the fifth embodiment relates to an AKA system. The AKA system may include:

a generating unit (71), configured to generate, upon reception of an authentication request from a terminal, a first authentication code according to a shared key with the terminal, a random number, and a first sequence number that represents the current system time of the network;

a sending unit (72), configured to send the random number, the first sequence number and the first authentication code generated by the generating unit (71) to the terminal; and

an authenticating unit (73), configured to check a response value from the terminal and determine that the terminal is legal if the check is successful.

The AKA system provided in this embodiment may execute the steps on the network in the AKA method in the first, second and third embodiments. The functional entities of the AKA system may be placed in one network element entity or placed separately in several network element entities on the network.

In this embodiment, because each terminal automatically increases the system time and the system time is unique, it is not necessary for the terminal to generate a second sequence number for the current authentication according to the second sequence number of the last authentication. Even if the user card cannot store the second sequence number of the last authentication or if the user card has changed to another terminal after the last authentication, a unique and correct second sequence number is generated for the current authentication. Therefore, the terminal does not mistake an authentication challenge replayed by an illegal network for a legal message due to the uncertain or incorrect second sequence number so that replay attacks are effectively resisted.

The sixth embodiment relates an authentication method. The authentication method may be an AKA method but is different from the method provided in the first to third embodiments mainly in that in the first to third embodiments, the entire AKA procedure uses the system time as the SQN while in this embodiment, the system time is used as a SQN to synchronize the SQN values on the terminal and the network only when a related SQN is absent on the terminal. In other AKA procedures, this embodiment still uses the SQN in the same sequence number mode as the prior AKA method.

Here, the condition where a terminal has no corresponding SQN value may be: the SQN needs to be maintained in the terminal other than in the user card, but the terminal does not have the SQN of the related user. For example, a terminal detects a new use card is inserted. In this case, the terminal uses its system time as a new SQN and initiates a resynchronization procedure in AKA and notifies the network of the new SQN. The network receives and stores the new SQN. In the following authentication procedure (that is, the following AKA procedure), the network maintains and uses the new SQN in the method provided in the prior art on the basis of the new SQN. In other words, the SQN sent by the network increases on the basis of the new SQN. The SQN stored according to the AKA method in the prior art increases with the increase of authentication times. Therefore, so long as the increase frequency of the SQN that represents the system time is higher than the authentication frequency of the terminal, the SQN representing the system time is larger than the SQN stored according to the AKA method when the SQN of the last authentication is unknown. For example, so long as the authentication frequency of a user is lower than once a second, the SQN generated based on the total of seconds of the system time is larger than the SQN stored according to the AKA method in the prior art. In this way, the resynchronized SQN is always larger than the SQN before synchronization, thus ensuring the strict monotonic increase feature of the SQN and avoiding replay attacks to a large extent.

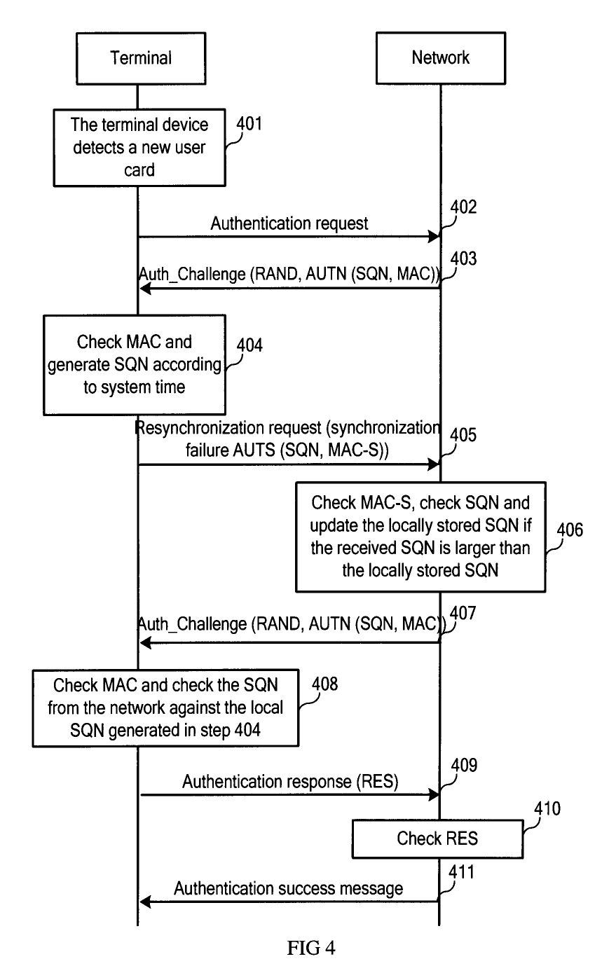

The specific procedure is shown in FIG. 4, including the following steps:

Step 401: A terminal device detects that a new user card is currently inserted, that is, the user changes the user card in the terminal, and deletes the SQN stored by the terminal for the old user card.

Step 402: The terminal initiates an AKA procedure.

Step 403: The network computes an AV and sends to the terminal an Auth_Challenge message which carries a RAND and an AUTN (including a SQN and a MAC). The SQN here is the SQN maintained by the network for the current user. If this is the first registration of the user, the SQN may be 0.

Step 404: The terminal receives the Auth-Challenge and computes an XMAC according to the RAND and the SQN in the message and the shared key of the current user, in the same method as the network uses to compute the MAC. The terminal compares the XMAC with the MAC carried in the Auth_Challenge message. If the MAC is incorrect, the terminal determines that the currently received Auth_Challenge is illegal and terminates the authentication procedure. The authentication fails. If the MAC is correct, the terminal continues to check whether a SQN of the user is stored locally. Because the current user card inserted in the terminal is changed, the terminal has not stored the SQN of the user. Therefore, the terminal generates a SQN according to its system time. Then step 405 follows.

Step 405: The terminal initiates a resynchronization request with the newly generated SQN. The resynchronization request message includes the parameter AUTS which includes a MAC-S of the SQN generated according to the system time.

Step 406: Upon reception of the resynchronization request, the network checks the correctness of the MAC-S in the AUTS. If the MAC-S is correct, the network checks whether the SQN in the AUTS is larger than the SQN currently stored by the network for the user. If the received SQN is larger than the locally stored SQN, the resynchronization request is valid. In this case, the network replaces the previously stored SQN with the SQN in the received authentication request.

Step 407: The network sends another Auth_Challenge message, which carries an AV that includes a SQN created by the network based on the SQN received in the step 406 according to the AKA method in the prior art. Specifically, the network adds a specific step, for example, 1, to the updated SQN.

Step 408: Upon reception of the new Auth_Challenge, the terminal checks the MAC and checks the SQN sent from the network against the local SQN generated in the step 404 after the MAC is determined correct. The check method is similar to the prior AKA procedure. If the check is successful, the network is authenticated successfully. Step 409 then proceeds.

Step 409: The terminal sends a response value RES to the network.

Step 410: The network checks the RES. If the check is successful, the network continues with step 411 to send an authentication success message to the terminal.

In the following AKA procedure, both the terminal and the network continue using the SQN synchronized in the above procedure. The specific authentication procedure is the same as the prior AKA procedure. If the terminal detects another change of a user card, the terminal executes step 401 again to resynchronize the SQN values on the terminal and the network by using the system time.

The effect of the prior AKA procedure in resisting replay attacks mainly depends on the synchronization and monotonic increase of the SQN on the terminal and the network. The authentication and resynchronization based on this embodiment may better ensure the monotonic increase of SQN, and therefore replay attacks may be better resisted. Specifically, in this embodiment, when the terminal detects that a new user card is inserted, the terminal generates a SQN according to system time and initiates SQN synchronization with the network with the generated SQN. This means, both the network and the terminal update the SQN they store with the SQN that represents the current system time of the terminal. If the terminal generates a SQN according to the total of seconds of system time, the SQN of the user before the terminal is used is smaller that the current time value so long as the authentication frequency of the new user using the terminal is lower than once a second. Therefore, in this embodiment, when the user card is inserted to a new terminal so that a new resynchronization procedure is initiated, the new SQN sent by the terminal to the network is larger than the SQN stored by the network for the user during the last authentication without the need to know the SQN of the user in the last authentication, so that the SQN of the user on both the terminal and the network always increases in a monotonic manner. Here, the condition that the authentication frequency of the user is lower than once a second is just an example without the intention to limit the disclosed embodiments. Even if the authentication frequency of the user is higher, another method can be adopted to guarantee that the SQN representing the current system time of the terminal is larger than the SQN stored during the last authentication. For example, the terminal may generate a SQN according to the total of milliseconds of the system time for a resynchronization. According to this embodiment, when the SQN is synchronized, the SQN values stored on the terminal and the network increase with each authentication without going beyond the system time. Therefore, when a new SQN synchronization is needed, the current system time can still serve the purpose.

In addition, unlike the first to third embodiments, this embodiment does not require the guarantee of clock synchronization between the terminal and the network for each authentication. Instead, it is only necessary to guarantee the clock synchronization before a SQN resynchronization. This lowers the requirement for time synchronization of the network and better fits the feature of a CDMA2000 network (because a terminal and a base station are well synchronized but it is not so easy for a device to be authenticated in a core network to keep synchronized with the base station). Therefore, this embodiment may be more practical.

It should be noted that in this embodiment, the terminal initiates a SQN resynchronization with the system time on the terminal, in addition to which, the network may initiate a SQN resynchronization with the system time on the network. For example, the network generates a SQN for the user according to its system time and sends the SQN to the terminal and the terminal makes judgment according to the received SQN. If the terminal already stores a SQN of the user locally, the terminal compares the locally stored SQN with the received SQN. If the received SQN is larger, the terminal updates the locally stored SQN with the received SQN. If the terminal does not store a SQN of the user locally, the terminal stores the received SQN directly.

In addition, in this embodiment, the terminal checks whether a SQN of the user is stored locally after the terminal receives an authentication challenge from the network. The terminal may also directly check whether a SQN of the user is stored locally when it is necessary to initiate an authentication request for the user and if the SQN of the user is stored locally, the terminal generates a SQN for the user according to the system time of the terminal and triggers a resynchronization procedure.

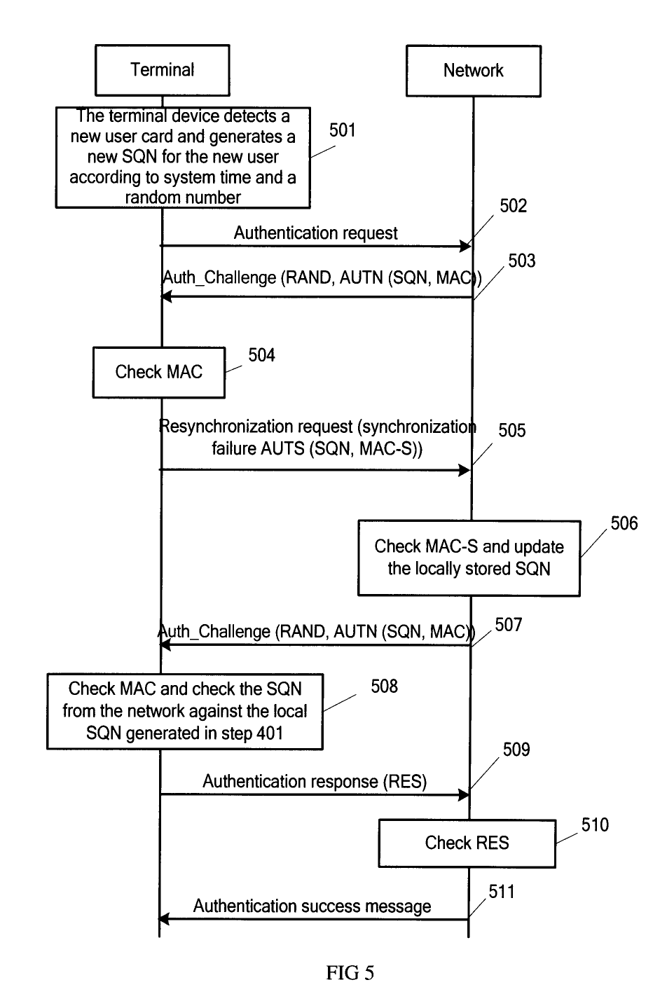

The seventh embodiment relates to an authentication method. Unlike the method according to the sixth embodiment, in this embodiment, when a related SQN does not exist on the terminal, the system time and a random number together serve as the SQN to synchronize the SQN on the terminal and the network. As shown in FIG. 5, the procedure may include the following steps:

Step 501: A terminal device detects that a new user card is currently inserted, that is, the user changes the user card in the terminal, and deletes the SQN stored by the terminal for the old user card. The terminal also generates a new SQN for the current user. For example, the terminal may set the most significant 32 bits of the SQN to the current system time value of the terminal and set the least signification 32 bits of the SQN to a generated random number.

Step 502: The terminal initiates an AKA procedure.

Step 503: The network computes an AV and sends to the terminal an Auth_Challenge message which carries a RAND and an AUTN (including a SQN and a MAC). The SQN here is the SQN maintained by the network for the current user. If this is the first registration of the user, the SQN may be 0.

Step 504: The terminal receives the Auth-Challenge and computes an XMAC according to the RAND and the SQN in the message and the shared key of the current user, in the same method as the network uses to compute the MAC. The terminal compares the XMAC with the MAC carried in the Auth_Challenge message. If the MAC values are not identical, the terminal determines that the currently received Auth_Challenge is illegal and terminates the authentication procedure. The authentication fails. If the MAC values are identical, the terminal ignores the received SQN and initiates a SQN synchronization procedure.

Step 505: The terminal initiates a resynchronization request with the newly generated SQN. The resynchronization request message includes the parameter AUTS which includes a MAC-S and the SQN generated according to the system time and the random number in the step 501.

Step 506: Upon reception of the resynchronization request, the network checks whether the MAC-S in the AUTS is correct. If the MAC-S is correct, the resynchronization request is valid and the network replaces the previously stored SQN with the SQN in the received resynchronization request.

Step 507: The network sends another Auth_Challenge message, which carries an AV that includes a SQN created by the network based on the SQN received in the step 506 according to the AKA method in the prior art. Specifically, the network adds a specific step, for example, 1, to the updated SQN.

Step 508: Upon reception of the new Auth_Challenge, the terminal checks the MAC and checks the SQN sent from the network against the local SQN generated in step 504 after the MAC is determined correct. The check method is similar to the prior AKA procedure. If the check is successful, the network is authenticated successfully. Step 509 then proceeds.

Step 509: The terminal sends a response value RES to the network.

Step 510: The network checks the RES. If the check is successful, the network continues with step 511 to send an authentication success message to the terminal.

In the following AKA procedure, both the terminal and the network continue using the SQN synchronized in the above procedure. The specific authentication procedure is the same as the prior AKA procedure. If the terminal detects another change of a user card, the terminal executes step 501 again to resynchronize the SQN values on the terminal and the network by using the system time and a random number.

In practice, to generate a SQN based on the system time and a random number makes the SQN value more random. Even if an attacker knows the time value or even controls the system time of the terminal, the attacker is unable to predict the SQN generated by the terminal so that a replay attack is improbable. The security is thus enhanced.

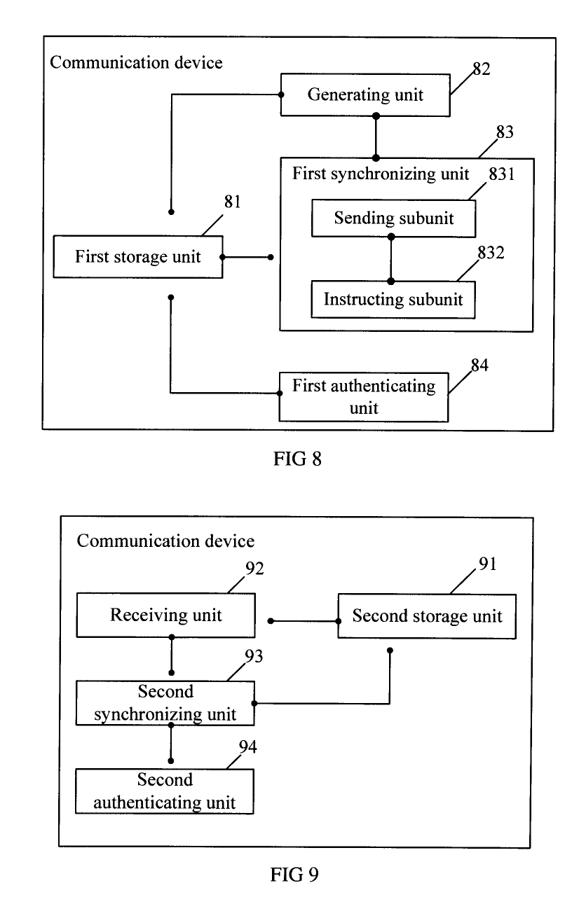

The eighth embodiment relates a communication device. As shown in FIG. 8, the communication device may include:

a first storage unit (81), configured to store a fourth sequence number of a user;

a generating unit (82), configured to generate the fourth sequence number according to the system time of the communication device after it is determined that the first storage unit (81) does not store the fourth sequence number for the user to be authenticated, and configured to instruct the first storage unit (81) to store the fourth sequence number; and

a first synchronizing unit (83), configured to synchronize a third sequence number of the user stored by a peer device with the fourth sequence number via communication between the communication device and the peer device.

In specific implementation, the first synchronizing unit (83) mainly includes:

a sending subunit (831), configured to send the fourth sequence number generated by the generating unit (82) to the peer device;

an instructing subunit (832), configured to instruct the peer device to update the third sequence number of the user stored by the peer device with the fourth sequence number; and

a first authenticating unit (84), configured to authenticate communication messages with the network to resist a replay attack by using the synchronized fourth sequence number.

In practice, the communication device in this embodiment may be a terminal device and the related peer device is a network element entity located on the network.

The ninth embodiment relates a communication device. As shown in FIG. 9, the communication device may include:

a second storage unit (91), configured to store a third sequence number of a user;

a receiving unit (92), configured to receive a fourth sequence number of the user to be authenticated from a terminal device;

a second synchronizing unit (93), configured to synchronize the third sequence number stored by the second storage unit (91) with the fourth sequence number received by the receiving unit (92); and

a second authenticating unit (94), configured to authenticate interactive messages with the peer device to resist a replay attack by using the synchronized third sequence number.

In practice, the communication device in this embodiment may be a network element entity on the network.

The third sequence number stored on the network increases with the increase of authentications and the system time increases automatically. Because it may be determined that the frequency of automatic increase of system time is higher than the frequency of terminal authentication, the fourth sequence number generated according to the system time is larger than the third and fourth sequence numbers previously stored on the network and the terminal. For example, if the frequency of terminal authentication is once 10 seconds, a fourth sequence number may be generated according to the total number of seconds associated with the system time. If the frequency of terminal authentication is once 10 milliseconds, a fourth sequence number may be generated according to the total number of milliseconds associated with the system time. In this way, it is guaranteed that the fourth sequence number generated according to the system time is larger than the sequence number obtained by increase with each authentication. Therefore, when the fourth sequence number generated according to the system time is adopted for the synchronization of sequence numbers between the network and the terminal, the sequence number after the resynchronization will increase while the currently stored third and fourth sequence numbers are unknown. This enables effective resistance against replay attacks and is especially fit for a resynchronization in the case that a user card which cannot store a fourth sequence number changes a terminal.

The second synchronizing unit (93) on the network completes synchronization as follows: if the second storage unit (91) already stores a third sequence number of the user, the second synchronizing unit (93) compares the fourth sequence number received by the receiving unit (92) with the third sequence number; if the fourth sequence number is larger than the third sequence number, the second synchronizing unit (93) instructs the second storage unit (91) to update the stored third sequence number with the fourth sequence number; if the second storage unit (91) does not store a third sequence number of the user, the second synchronizing unit (93) instructs the second storage unit (91) to store the fourth sequence number received by the receiving unit (92) as the third sequence number.

Consistent with the disclosed embodiments, when the network receives an authentication request from a terminal, the network generates a first authentication code MAC according to a shared key with the terminal, a random number and a first sequence number SQN1 that represents the current system time of the network and sends the random number, the SQN1 and the MAC to the terminal; the terminal generates a second authentication code XMAC according to a shared key with the network and the received random number and SQN1; if the XMAC is identical with the MAC and the difference between a second sequence number SQN2 that represents the system time of the terminal and the SQN1 meets a preset condition, the terminal determines that the network is legal; if the XMAC is different from the MAC but difference between the SQN2 on the terminal and the SQN1 on the network does not meet the preset condition, the terminal determines that the message carrying the random number, the SQN1 and the MAC is sent by the network at an earlier time and may be replicated and replayed by an illegal network. Thus, the terminal considers the message insecure and the authentication fails. Because each terminal automatically determines a unique system time, it is not necessary for the terminal to generate a SQN2 for the current authentication according to the SQN2 of the last authentication. Even if the user card cannot store the SQN2 of the last authentication or if the user card has changed to another terminal after the last authentication, a unique and correct SQN2 is generated for the current authentication. Therefore, the terminal does not mistake the random number, SQN1 and MAC replayed by an illegal network for legal ones due to an uncertain or incorrect SQN2 so that replay attacks are effectively resisted.

The preset condition for making judgment may be set as required. The preset condition may be: the absolute difference between the SQN2 and the SQN1 is smaller than a preset threshold or the difference between the SQN2 and the SQN1 is within a preset range. With this preset condition, the judgment on whether an authentication challenge sent by the network that carries a random number, a SQN1 and a MAC is legal may be controlled in a reasonable scope to satisfy the requirements of different services.

Before a terminal and/or a network starts an authentication, it is necessary to guarantee synchronization of the system clocks on both sides. For example, before the terminal sends an authentication request, or before the network generates the first authentication code, a clock synchronization procedure may be initiated so as to ensure that the impact of the difference between the system time values on the terminal and the network is in an insignificant range so that the terminal can correctly determine the legality of the authentication challenge message it receives.

If a second device (such as a terminal) determines that a fourth sequence number of the user to be authenticated is not stored locally, the second device generates a fourth sequence number according to the local system time and interacts with a first device (such as a device on the network) so as to synchronize the third sequence number of the user stored by the network with the fourth sequence number. The terminal and the network use the synchronized third and fourth sequence numbers to perform an anti-replay authentication on the interactive messages. The third sequence number stored on the network increases with the increase of authentications and the system time increases automatically. Because it is easy to guarantee that the frequency of automatic increase of system time is higher than the frequency of terminal authentication, the fourth sequence number generated according to the system time is larger than the third and fourth sequence numbers previously stored on the network and the terminal. For example, if the frequency of terminal authentication is once 10 seconds, a fourth sequence number may be generated according to the total number of seconds associated with the system time. If the frequency of terminal authentication is once 10 milliseconds, a fourth sequence number may be generated according to the total number of milliseconds associated with the system time. In this way, it is guaranteed that the fourth sequence number generated according to the system time is larger than the sequence number obtained by increase with each authentication. Therefore, when the fourth sequence number generated according to the system time is adopted for the synchronization of sequence numbers between the network and the terminal, the sequence number after the resynchronization will increase while the currently stored third and fourth sequence numbers are unknown. This enables effective resistance against replay attacks and is especially fit for a resynchronization in the case that a user card which cannot store a fourth sequence number changes a terminal.

Although the technical scheme of the embodiments has been described through exemplary embodiments, the disclosed embodiments are not limited to such embodiments. It is apparent that those skilled in the art can make various modifications and variations to the disclosed embodiments without departing from the spirit and scope of the embodiments. The disclosed embodiments are intended to cover the modifications and variations provided that they fall in the scope of protection defined by the claims or their equivalents.

What is claimed is:

1. An authentication method, comprising:
generating, by a second device, a fourth sequence number for a user according to a system time of the second device if the second device determines that the fourth sequence number for the user is not stored in the second device and synchronizing a third sequence number of the user that is stored by a first device with the fourth sequence number by interacting with the first device; and
performing, by the second device and the first device, an anti-replay protection in authentication using the synchronized third sequence number and the fourth sequence number.

2. The authentication method of claim 1, wherein the synchronizing the third sequence number of the user that is stored by the first device with the fourth sequence number by interacting with the first device comprises:
sending, by the second device, the fourth sequence number to the first device to make the first device update the third sequence number of the user with the fourth sequence number upon reception of the fourth sequence number.

3. The authentication method of claim 2, wherein the updating the third sequence number of the user with the fourth sequence number upon reception of the fourth sequence number comprises:
comparing, by the first device, the fourth sequence number with the third sequence number of the user stored by the first device if the first device already stores a third sequence number of the user, and updating the third sequence number with the fourth sequence number if the fourth sequence number is larger than the third sequence number; or
storing, by the first device, the fourth sequence number received from the second device as the third sequence number if the first device does not store a third sequence number of the user.

4. The authentication method of claim 2, wherein the updating the third sequence number of the user with the fourth sequence number upon reception of the fourth sequence number comprises:
judging, by the first device, whether the system time of the second device presented by the fourth sequence number is synchronized with a current system time of the first device if the first device already stores a third sequence number of the user, and updating the third sequence number with the fourth sequence number if the judgment result is yes; or
storing, by the first device, the fourth sequence number received from the second device as the third sequence number if the first device does not store a third sequence number of the user.

5. The authentication method of claim 1, wherein the performing the anti-replay protection in authentication using the synchronized third sequence number and the fourth sequence number comprises:
adding, by the first device, a preset step to the synchronized third sequence number and sending a step-added third sequence number to the second device by carrying the third sequence number in a message to be authenticated; and
comparing, by the second device, the synchronized fourth sequence number with the step-added third sequence number carried in the message to be authenticated, determining that anti-replay verification of the message is successful if a comparison result meets a first preset condition, and updating the fourth sequence number with the step-added third sequence number; or determining that anti-replay verification of the message fails if the comparison result does not meet the first preset condition.

6. The authentication method of claim 5, wherein the first preset condition comprises: the step-added third sequence number carried in the message to be authenticated is larger than the synchronized fourth sequence number of the second device; or the step-added third sequence number carried in the message to be authenticated is larger than the synchronized fourth sequence number of the second device and a difference between the two is within a preset range.

7. The authentication method of claim 1, wherein the fourth sequence number comprises two parts: a first part is generated according to system time of the second device and a second part is a random number.

8. The authentication method of claim 1, further comprising:
checking, by the second device, whether the second device stores a fourth sequence number for the user when the second device receives a message of the user to be authenticated from the first device, or when the second device needs to initiate authentication for the user, or when the second device detects a new user card is inserted.

9. A communication device, comprising:
a first storage unit, configured to store a fourth sequence number of a user;
a generating unit, configured to generate the fourth sequence number according to system time of the communication device after it is determined that the first storage unit does not store the fourth sequence number for the user to be authenticated, and configured to instruct the first storage unit to store the fourth sequence number;
a first synchronization unit, configured to synchronize a third sequence number of the user stored by a peer device with the fourth sequence number by communicating with the another communication device; and
a first authenticating unit, configured to perform an anti-replay authentication on interactive messages with the peer device by using the synchronized fourth sequence number.

10. The communication device of claim 9, wherein the first synchronizing unit further comprises:
a sending subunit, configured to send the fourth sequence number generated by the generating unit to the peer device; and
an instructing subunit, configured to instruct the peer device to update the third sequence number of the user stored by the peer device with the fourth sequence number.

11. An Authentication and Key Agreement (AKA) method, comprising:
sending, by a terminal, a registration request or an authentication request to a network;
obtaining, by the terminal, from the network a first sequence number that represents current system time of the network and a random number and a first authentication code of the network, wherein the first authentication code is generated by the network according to a shared key between the network the terminal, the random number and the first sequence number;
checking, by the terminal, the first sequence number and the first authentication code and determining that the network is legal when the following condition is met:
a second authentication code generated according to the shared key, the random number and the first sequence number is identical with the first authentication code; and
difference between the second sequence number that represents current system time of the terminal and the first sequence number meets a preset condition.

12. The AKA method of claim 11, further comprising:
generating, by the terminal, a response value according to the shared key and the random number after determining that the network is legal and sending the response value to the network

13. The AKA method of claim 11, wherein length of the first sequence number and the second sequence number is equal to or less than 48 bits; or
both the first sequence number and the second sequence number comprise a length of a first part less than or equal to 32 bits and a length of a second part less than or equal to 16 bits.

14. The AKA method of claim 11, wherein the preset condition is:
absolute difference between the second sequence number and the first sequence number is smaller than a preset threshold; or
difference between the second sequence number and the first sequence number is within a preset range.

15. The AKA method of claim 11, wherein the terminal guarantees synchronization with a system clock of the network before sending the authentication request.

16. The AKA method of any of claims 11, wherein if the terminal finds that difference between the second sequence number and the first sequence number does not meet the preset condition, the method further comprises:
sending, by the terminal, the second sequence number to the network to make the network perform a clock synchronization procedure between the terminal and the network according to a system time represented by the second sequence number.
